(19) United States
(12) Patent Application Publication
(10) Pub. No.: US 2026/0360325 A1
(43) Pub. Date: Nov. 12, 2026

(54) ELECTRONIC PAPER DISPLAY DEVICE AND DRIVING METHOD THEREOF

(71) Applicant: E Ink Holdings Inc., Hsinchu (TW)

(72) Inventors: Shu-Cheng Liu, Hsinchu (TW); Pei-Lin Tien, Hsinchu (TW)

(73) Assignee: E Ink Holdings Inc., Hsinchu (TW)

(21) Appl. No.: 19/653,135

(22) Filed: Apr. 21, 2026

(30) Foreign Application Priority Data
May 7, 2025 (TW) 114117085

(51) Int. Cl. G09G 3/34; G09G 3/20

(52) U.S. Cl. CPC G09G 3/344; G09G 3/2096; G09G 2320/0285; G09G 2340/16

(57) ABSTRACT

An electronic paper display device and a driving method of the electronic display device are provided and are capable of accelerating display screen updates. The electronic paper display device includes an electronic paper display panel, a host, and a controller. The host provides image data. In a frame updating period, when the image data are updated from first image data to second image data, the controller interrupts driving the electronic paper display panel to display the first image data based on a first control signal generated from the first image data, and generates a second control signal to drive the electronic paper display panel to display the second image data according to current image data, the second image data, and a lookup table.

### CROSS-REFERENCE TO RELATED APPLICATION

This application claims the priority benefit of Taiwan application serial no. 114117085, filed on May 7, 2025. The entirety of the above-mentioned patent application is hereby incorporated by reference herein and made a part of this specification.

### BACKGROUND

### Technical field

The disclosure relates to a display device and particularly relates to an electronic paper display device and a driving method thereof.

### Description of the Related Art

Generally, an electronic paper display performs display by driving the movement of electrophoretic particles through a control circuit based on the image content. However, when the image content changes, for instance, from a black pattern to a white pattern, the conventional control circuit cannot interrupt the ongoing driving operation for the black pattern and continues to drive the electrophoretic particles to display the black pattern. As a result, the conventional electronic paper display is constrained by the duration of the driving operation and is unable to update the display frame quickly.

### SUMMARY

In one or more embodiments of the disclosure, an electronic paper display device that can accelerate display frame updates when image data are updated is provided.

An electronic paper display device provided in one or more embodiments of the disclosure includes an electronic paper display panel, a host, and a controller. The host is configured to provide image data. The controller is coupled to the host and the electronic paper display panel. In a frame updating period, when the image data are updated from first image data to second image data, the controller is configured to interrupt driving the electronic paper display panel to display the first image data based on a first control signal generated from the first image data, and generate a second control signal according to current image data, the second image data, and a lookup table to drive the electronic paper display panel to display the second image data.

A driving method of an electronic paper display device provided in one or more embodiments of the disclosure includes following steps. In a frame updating period, when image data are updated from first image data to second image data, driving an electronic paper display panel to display the first image data based on a first control signal generated from the first image data is interrupted through a controller. In the frame updating period, a second control signal is generated through the controller according to current image data, the second image data, and a lookup table to drive the electronic paper display panel to display the second image data.

Based on the above, in the electronic paper display device and the driving method thereof provided in one or more embodiments of the disclosure, the current driving operation is interrupted through the controller in response to new target image data (i.e., the second image data), so that the driving period of the complete frame (i.e., the frame updating period) no longer imposes a limitation. As a result, the electronic paper display device can accelerate the display frame updates by allowing the controller to continue to the driving operation corresponding to the second image data based on the current image data.

In order to make the above-mentioned features and advantages of the disclosure comprehensible, embodiments accompanied with drawings are described in detail below.

### BRIEF DESCRIPTION OF THE DRAWINGS

The accompanying drawings, which are included to provide a further understanding of the disclosure, are incorporated in and constitute a part of this specification. The drawings illustrate embodiments of the disclosure and, together with the description, serve to explain the principles of the disclosure.

FIG. 1 is a circuit block diagram illustrating an electronic paper display device according to an embodiment of the disclosure.

FIG. 2 is a flowchart illustrating a control method of an electronic paper display device according to an embodiment of the disclosure.

FIG. 3 is a circuit block diagram illustrating an electronic paper display device according to another embodiment of the disclosure.

FIG. 4 is a schematic diagram illustrating actions of the electronic paper display device according to the embodiment of the disclosure depicted in FIG. 3.

FIG. 5 is a schematic diagram illustrating actions of the electronic paper display device according to the embodiment of the disclosure depicted in FIG. 3.

### DESCRIPTION OF THE EMBODIMENTS

Some embodiments of the disclosure will be described in detail with reference to the accompanying drawings. In the following description, when the same reference numbers appear in different drawings, they will be regarded as the same or similar elements. These embodiments are only a part of the disclosure and do not reveal all possible implementation manners of the disclosure. More precisely, these embodiments simply serve as examples within the scope of the claims of the disclosure.

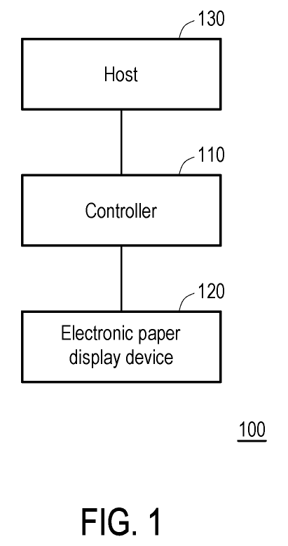

FIG. 1 is a circuit block diagram illustrating an electronic paper display device according to an embodiment of the disclosure. With reference to FIG. 1, an electronic paper display device 100 includes a controller 110, an electronic paper display panel 120, and a host 130. The controller 110 is coupled to the electronic paper display panel 120 and the host 130.

The electronic paper display panel 120 can be, for instance, a display panel including a plurality of pixel units, such as microcapsules or microcups. The pixel units can have electrophoretic particles of two or more colors (for instance, white electrophoretic particles and black electrophoretic particles, which should however not be construed as a limitation in the disclosure).

The host 130 is configured to provide image data. The image data can serve as a display frame of the electronic paper display panel 120. The host 130 can be, for instance, a micro control unit (MCU), a system on a chip (SoC), a graphics processing unit (GPU), or any other similar device or a combination of these devices.

The controller 110 is configured to compare current image data and target image data provided by the host 130 and generate control signals according to the comparison result based on a lookup table. The controller 110 is further configured to output the control signals to the electronic paper display panel 120, so that a driver in the electronic paper display panel 120 drives the pixel units based on the control signals. The controller 110 can be, for instance, a timing controller (TCON).

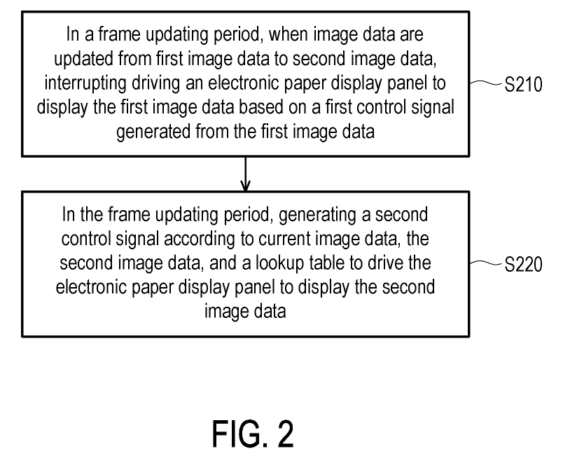

FIG. 2 is a flowchart illustrating a control method of an electronic paper display device according to an embodiment of the disclosure. With reference to FIGS. 1 and 2, the electronic paper display device 100 executes steps S210 to S220. The sequence of these steps S210 to S220 is simply for illustrative purposes.

In this embodiment, the controller 110 compares the current image data and the target image data (e.g., the first image data) provided by the host 130. The controller 110 generates the first control signal according to the comparison result based on the lookup table. In the frame updating period, the controller 110 outputs the first control signal to the electronic paper display panel 120 to drive the electronic paper display panel 120 to display the target image data (i.e., the first image data). The frame updating period can be, for instance, a period during which the electronic paper display panel 120 is driven to display the first image data.

In step S210, in the frame updating period, when the image data are updated from the first image data to the second image data, the controller 110 interrupts driving the electronic paper display panel 120 to display the first image data based on the first control signal generated from the first image data. That is, before the electronic paper display panel 120 completes displaying the first image data, the host 130 updates the target image data to the second image data. At this time, the controller 110 interrupts the current driving operation for the first image data.

In step S220, in the frame updating period, the controller 110 generates a second control signal according to the current image data, the second image data, and the lookup table to drive the electronic paper display panel 120 to display the second image data. That is, in the period of driving the electronic paper display panel 120 to display the original target image data (i.e., the first image data), after interrupting the driving operation for the first image data, the controller 110 continues the driving operation for the second image data.

It is worth mentioning that in response to the new target image data (i.e., the second image data), during a frame period when the electronic paper display panel 120 has not yet completed updating the first image data, the controller 110 can interrupt the driving operation for the first image data. The controller 110 can also continue the driving operation for the second image data based on the current image data. As such, the electronic paper display device 100 is not limited by the driving period of a complete frame (i.e., the frame updating period), thereby accelerating the display of the target image data.

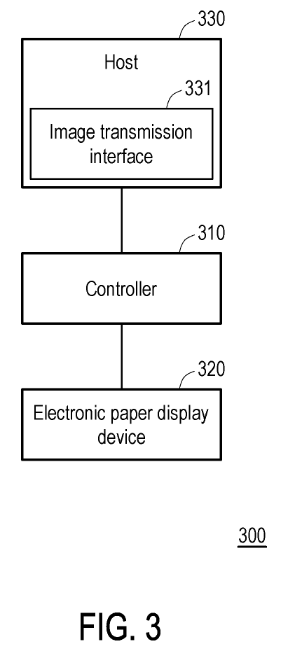

FIG. 3 is a circuit block diagram illustrating an electronic paper display device according to another embodiment of the disclosure. The electronic paper display device 300 includes a controller 310, an electronic paper display panel 320, and a host 330. The controller 310, the electronic paper display panel 320, and the host 330 can be deduced from and can refer to the relevant descriptions of the electronic paper display device 100.

In the embodiment depicted in FIG. 3, the host 330 includes an image transmission interface 331. The host 330 is coupled to the controller 310 through the image transmission interface 331. The image transmission interface 331 can transmit the image data to the controller 310 at a speed of, for instance, 20 frame per second (FPS, frame updating rate).

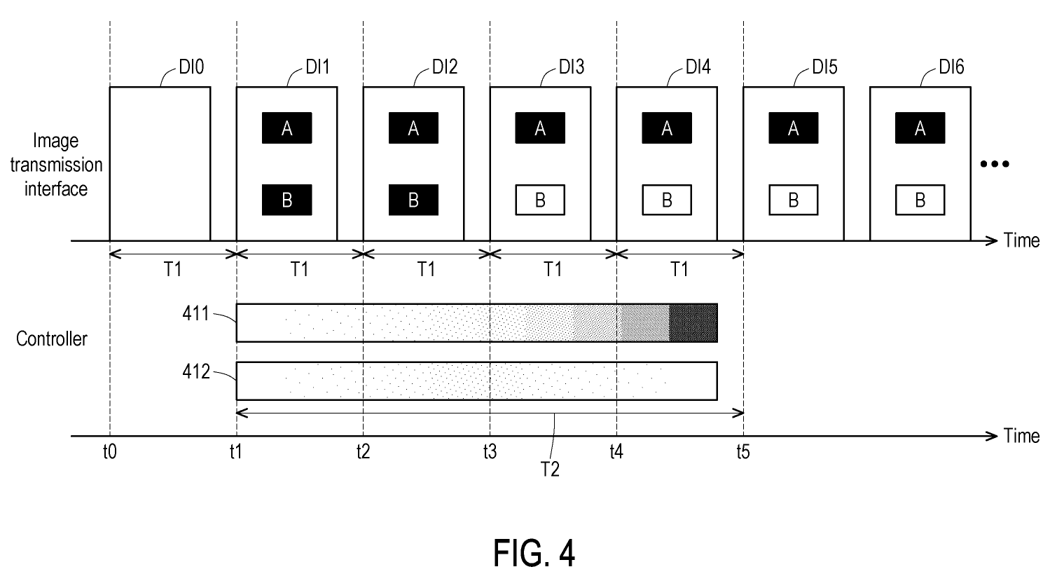

Please also refer to FIG. 4, which is a schematic diagram illustrating actions of the electronic paper display device according to the embodiment of the disclosure depicted in FIG. 3. In FIG. 4, the horizontal axis represents the operation time of the electronic paper display device 300, and the vertical axis represents the schematic diagram of the image operated by the electronic paper display device 300.

In the embodiments depicted in FIGS. 3 and 4 , the host 330 sequentially transmits image data DI0 to DI6 to the controller 310 through the image transmission interface 331. Assuming the frame updating rate is 20 FPS, the total transmission time required for each image data DI0 to DI6 can be, for instance, a first period T1 (e.g., 50 ms). The controller 310 takes the currently (e.g., at time t1) received image data (e.g., the image data DI1 received at the time t1) as the target image data. The controller 310 compares the image data received at the previous moment (e.g., the initialized image data DI0) with the target image data DI1. The controller 310, based on the lookup table, generates the corresponding control signals according to the comparison result, so that the display controller 310 drives the electronic paper display panel 320 to display the target image data according to the control signals.

In the electronic paper display panel 320, a plurality of pixel units require a second period T2 (e.g., 200 ms) to complete the desired full color change (e.g., changing from all black to all white, or from all white to all black). The second period T2 can be, for instance, the frame updating period required for the electronic paper display panel 320 to completely display the target image data.

Taking a pattern A changing from all white to all black as an example, a bar 411 signifies "a duration during which the controller 310 generates the corresponding control signals to change the pattern A from all white to all black," where the background color of the bar 411 indicates the degree of color change of the particles. The duration can start, for instance, from the time t1, and as time extends, the particles are driven to make the background color of the bar 411 gradually change from all white to all black. In this embodiment, since the content corresponding to the pattern A remains black without change, the control signals corresponding to the bar 411 keep on instructing the particles to change from the white state to the black state and complete the above in the second period T2 (e.g., 200 ms).

Compared to the pattern A, a pattern B changes from all white to all black, and then changes to all white again at time t3. A bar 412 signifies "a duration during which the controller 310 generates the corresponding control signals to change the pattern B from all white to all black, and from all black to all white," where the background color of the bar 412 indicates the degree of color change of the particles. The duration can start, for instance, from the time t1, and as time extends, the particles are driven to make the background color of the bar 412 gradually change from all white to black until interrupted at the time t3, resulting in a grayscale state. The background color of the bar 412 also shows a gradual change from the grayscale state to all white starting from the time t3. In this embodiment, since the content corresponding to the pattern B changes at the time t3 (i.e., from all black to all white), the control signals corresponding to the bar 412 include instructions to the particles to change from the white state to the black state at the time t1 and instructions to the particles to change from the current grayscale state to the white state at the time t3, and completes the above in the second period T2 (e.g., 200 ms).

In detail, at the time t0, the image transmission interface 331 transmits the initialized image data DI0 to the controller 310. The controller 310 temporarily stores the image data DI0.

At the time t1, the image transmission interface 331 transmits the image data DI1 to the controller 310. The controller 310 compares the image data DI0 received at the previous moment t0 with the currently received image data DI1. Based on the lookup table, the controller 310 calculates waveform sequence data according to the comparison result. The controller 310 generates the corresponding control signals according to the waveform sequence data to drive the electronic paper display panel 320 to display the image data DI1. As such, in the pattern A, the particles corresponding to the bar 411 appear white. In the pattern B, the particles corresponding to the bar 412 also appear white.

At the time t2, the image transmission interface 331 transmits the image data DI2 to the controller 310. The controller 310 compares the image data DI1 received at the previous moment t1 with the currently received image data DI2. The controller 310 determines from the comparison result that no pixel units need to change state. The controller 310 continues to drive the electronic paper display panel 320 to display the image data DI1 using the control signals generated at the time t1. As such, in the pattern A, the particles corresponding to the bar 411 gradually change from white to black, resulting in a grayscale state. Similarly, in the pattern B, the particles corresponding to the bar 412 also appear in a grayscale state.

At the time t3, the image transmission interface 331 transmits the image data DI3 to the controller 310. The controller 310 compares the image data DI1 with the currently received image data DI3. The comparison result indicates that the pattern B changes from all black to all white. The controller 310 interrupts the control signals generated based on the image data DI1 that drive the electronic paper display panel 320 to display the image data DI1 according to the comparison result. The image data DI1 can be, for instance, the first image data provided in the embodiment depicted in FIGS. 1 and 2 , and the image data DI3 can be, for instance, the second image data.

At this time, the controller 310 records the image data when the electronic paper display panel 320 is interrupted from displaying the image data DI1 as the current image data. The controller 310 also records the interrupted driving frame moment (i.e., the time t3) when the electronic paper display panel 320 is interrupted from displaying the image data DI1.

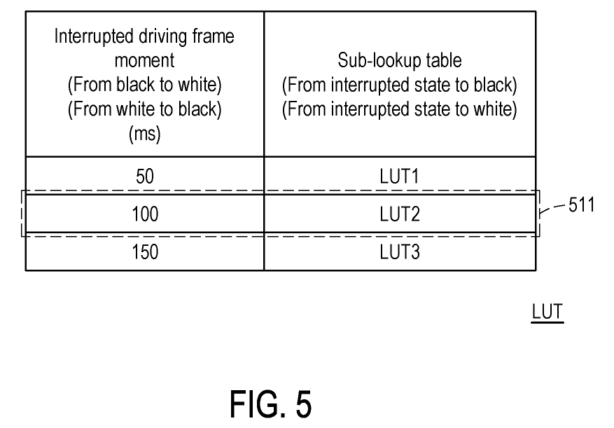

Please also refer to FIG. 5, which is a schematic diagram illustrating actions of the electronic paper display device according to the embodiment of the disclosure depicted in FIG. 3. The controller 310 can access a lookup table LUT. In this embodiment, the lookup table LUT includes a plurality of sub-lookup tables LUT1 to LUT3 corresponding to a plurality of interrupted driving frame moments. Each of the sub-lookup tables LUT1 to LUT3 includes the corresponding relationship between grayscale codes and the control signals (including various voltage combinations of waveform sequences).

The controller 310 looks up the lookup table LUT according to the interrupted driving frame moment (i.e., the time t3) to obtain the sub-lookup table LUT2, as shown in a box 511. Specifically, the controller 310 calculates the time difference between the moment of starting to drive the image data DI1 (i.e., the time t1) and the interrupted driving frame moment (i.e., the time t3). The time difference can be, for instance, two first periods T1, i.e., 100 ms. The controller 310 selects the sub-lookup table LUT2 according to the time difference.

Next, the controller 310 calculates waveform sequence data according to the current image data, the updated target image data (i.e., the image data DI3), and the sub-lookup table LUT2. The controller 310 generates the control signals corresponding to the image data DI3 according to the waveform sequence data to drive the electronic paper display panel 320 to display the image data DI3.

It should be noted that in the frame updating period (i.e., the second period T2) when the pattern B changes from all white to all black; at the time t3, in response to the new target image data DI3, the controller 310 interrupts the operation of driving the pattern B to transition from all white to all black. Based on the current image data, the controller 310 then continues the operation of driving the pattern B to change from its current state to all white. As a result, in the pattern B, the particles corresponding to the bar 412 first display a grayscale state and subsequently transition to white. In the pattern A, the particles corresponding to the bar 411 display a grayscale state and subsequently transition to black.

At the time t4, the operation of the electronic paper display device 300 can be understood by referring to the operation details at the time t2 and deduced therefrom accordingly. As a result, in the pattern B, the particles corresponding to the bar 412 gradually change from a grayscale state to white. In the pattern A, the particles corresponding to the bar 411 gradually change from a grayscale state to black.

To sum up, in the electronic paper display device and the driving method thereof provided in one or more embodiments of the disclosure, the controller interrupts the driving operation for the previous image data in response to new target image data. As a result, the driving period of the complete frame is no longer a limiting factor. The electronic paper display device can accelerate display frame updates by allowing the controller to continue the driving operation for the new target image data based on the current image data.

It will be apparent to those skilled in the art that various modifications and variations may be made to the disclosed embodiments without departing from the scope or spirit of the disclosure. In view of the foregoing, it is intended that the disclosure covers modifications and variations provided they fall within the scope of the following claims and their equivalents.

What is claimed is:

1. An electronic paper display device, comprising:
an electronic paper display panel;
a host, configured to provide image data; and
a controller, coupled to the host and the electronic paper display panel, wherein in a frame updating period, when the image data are updated from first image data to second image data, the controller is configured to:
interrupt driving the electronic paper display panel to display the first image data based on a first control signal generated from the first image data; and
generate a second control signal according to current image data, the second image data, and a lookup table to drive the electronic paper display panel to display the second image data.

2. The electronic paper display device according to claim 1, wherein the controller is further configured to:
record the image data as the current image data when the electronic paper display panel is interrupted from displaying the first image data.

3. The electronic paper display device according to claim 1, wherein the controller is further configured to:
record an interrupted driving frame moment when the electronic paper display panel is interrupted from displaying the first image data.

4. The electronic paper display device according to claim 3, wherein the controller is further configured to:
look up the lookup table to obtain a sub-lookup table according to the interrupted driving frame moment;
calculate waveform sequence data according to the current image data, the second image data, and the sub-lookup table; and
generate the second control signal according to the waveform sequence data.

5. The electronic paper display device according to claim 1, wherein the lookup table comprises a plurality of sub-lookup tables corresponding to a plurality of interrupted driving frame moments.

6. A driving method of an electronic paper display device, comprising:
in a frame updating period, when image data are updated from first image data to second image data, interrupting, through a controller, driving an electronic paper display panel to display the first image data based on a first control signal generated from the first image data; and
in the frame updating period, generating a second control signal through the controller according to current image data, the second image data, and a lookup table to drive the electronic paper display panel to display the second image data.

7. The driving method according to claim 6, further comprising:
recording the image data as the current image data through the controller when the electronic paper display panel is interrupted from displaying the first image data.

8. The driving method according to claim 6, further comprising:
recording through the controller an interrupted driving frame moment when the electronic paper display panel is interrupted from displaying the first image data.

9. The driving method according to claim 8, further comprising:
looking up the lookup table through the controller to obtain a sub-lookup table according to the interrupted driving frame moment;
calculating waveform sequence data through the controller according to the current image data, the second image data, and the sub-lookup table; and
generating the second control signal through the controller according to the waveform sequence data.

10. The driving method according to claim 6, wherein the lookup table comprises a plurality of sub-lookup tables corresponding to a plurality of interrupted driving frame moments.
